(19) United States
(12) Patent Application Publication
(10) Pub. No.: US 2015/0010141 A1
(43) Pub. Date: Jan. 8, 2015

(54) SYSTEM AND METHOD FOR GENERATING NATURAL LANGUAGE COMMENTS IN A TELECOMMUNICATION SYSTEM

(71) Applicant: Gurbirinder Singh SANDHU, Haryana (IN)

(72) Inventor: Gurbirinder Singh SANDHU, Haryana (IN)

(21) Appl. No.: 14/192,714

(22) Filed: Feb. 27, 2014

(30) Foreign Application Priority Data
Jul. 3, 2013 (IN) 1980/DEL/2013

(51) Int. Cl. H04M 3/51; G06F 17/20

(52) U.S. Cl. CPC H04M 3/51; G06F 17/20
USPC 379/266.07

(57) ABSTRACT

A system and method for generating a list of natural language comments during a telecommunication session between a customer and an operator wherein the system and method comprises of receiving a geographical code corresponding to the customer's location and obtaining data associated with the geographical code and processing the obtained data to generate a dynamic interface which comprises of a contextual content and the list of natural language comments.

### CROSS REFERENCE TO RELATED APPLICATION

This application claims the benefit of Indian Application No. 1980/DEL/2013, filed Jul. 3, 2013 by the present inventor.

### FIELD OF THE INVENTION

This invention relates to telemarketing tools used in the contact centers. This invention more particularly relates to a comment generation system for generating a list of natural language comments, queries and suggestions during a telecommunication session between a customer and an operator.

### BACKGROUND OF THE INVENTION

Call centers or contact centers are commonly used by service providers or manufacturers (collectively, “vendors”) to provide customer support. Customers requesting customer support may contact the call center by telephone. These call center resources are most usually human agents who speak with or message interactively with the customer.

A positive customer relationship and rapport is important for building trust and satisfaction in a sales or service transaction. Building a positive rapport is challenging in today's environment of call centers that may be located some distance from the customers, often in different geographic regions. Many times, the call center agents are not able to establish a good relationship with customers due to their lack of understanding of the local demographic, news and other cultural matters. Both customers as well as service providers, who may live in different cultures, may find it hard to communicate without anything common to discuss.

The call centre telemarketers use various sales tools that display information related to the customer's profile for assisting them in breaking the ice with the customer in initial minutes of conversation.

US 2006/0095326 discloses one such sales tool for improving customer service which comprises of a computer system including a processor, program, and network communication interface, wherein the computer system is configured to receive a geographic identifier, and configured to retrieve content relevant to the geographic identifier and provide the content to an operator.

However, simply presenting the contextual information around a caller's location is not very effective since the call center agents do not know how to use it in the conversation. Also sometimes the call center agents lack the grasp of the English language, which can result in awkward pauses in-between a conversation. The call center agents also need to be trained in the context of not saying statements or referring subjects to the customer which are politically and culturally incorrect. Often sometimes the agents accidently say things which are against the company policies. Therefore it is an arduous task to train the majority of the agents on using the information effectively. Thus it is important to feed the call center agents with relevant queries or comments and not just information.

The known tools that are used for call centers, customer support centers and technical support centers to empower customer service representatives and telesales and telemarketing professionals pose a limitation as they are not dynamic in nature and they usually present a set of questions for the telemarketer to use. Such tools lack in effectiveness as they do not cater to building a rapport with the customer at the start of telecommunication session.

Therefore, what is needed is an improved method and system to present dynamic content which can be used by call center personnel to steer the conversation in their favor, build trust and consummate a transaction with customer.

### SUMMARY OF THE INVENTION

It is an object of the invention to provide a comment generation system that enables call center agents to build rapport over the phone, by using contextually relevant conversational comments to break the ice.

It is an object of the invention to provide a method for generating a list of natural language comments during a telecommunication session between a customer and an operator.

It is still another object of the invention to provide a method for generating a list of natural language comments wherein the method comprises of receiving a geographical code corresponding to the customer's location and obtaining a first dataset from a repository and a second dataset from at least one dynamic source, processing the first dataset and the second dataset by a comment generator to generate a dynamic interface, wherein the dynamic interface comprises of a contextual content and the list of natural language comments and retrieving the dynamic interface to be used subsequently by the operator in the communication session.

It is still another object of the invention, to provide a comment generation system wherein the geographical code is selected from a group consisting of telecommunication phone number or postal code.

It is still another object of the invention, to provide a comment generation system wherein the geographical code is retrieved automatically from existing customer database or telecommunication phone number database or can be verbally requested from the customer by the operator during the telecommunication session.

It is still another object of the invention, to provide a comment generation system which is customized for a pre-defined set of customers.

It is still another object of the invention, to provide a comment generation system which is customized as per company policies.

It is still another object of the invention, to provide a comment generation system which takes dynamic inputs from the social media account of the customer.

It is still another object of the invention, to provide a comment generation system wherein the first dataset comprises of data related to at least one of news, area attractions, educational institutes, regional sports teams, demographic history, upcoming events, festivals, holidays and observances.

It is still another object of the invention, to provide a comment generation system wherein the second dataset comprises of data related to date, time, current weather and weather forecast.

It is still another object of the invention, to provide a comment generation system wherein the list of natural language comments is generated on the basis of the contextual content generated on the dynamic interface by the comment generation system.

It is still another object of the invention, to provide a comment generation system which is useful when a company employs sales and customer service personnel who are located at geographically distant locations from the customers.

It is still another object of the invention, to provide a comment generation system wherein the natural language comment is a meaningful sentence in a predefined language.

It is still another object of the invention, to provide a comment generation system wherein the natural language can be English or Hindi or any other language.

It is still another object of the invention, to provide a comment generation system which can generate comments in natural language or translated language.

It is still another object of the invention, to provide a comment generation system wherein the natural language comments are dynamically generated in real-time, based on information relevant to the caller's location and the date and time, resulting in a better call experience for all.

It is still another object of the invention, to provide a comment generation system which has the ability to provide improved sales and customer service in call center or an online chat room or social media chat.

It is still another object of the invention, to provide a comment generation system which is intuitive and flexible and can be customized by each service provider.

It is still another object of the invention, to provide a comment generation system which is powerful and agile, easy to use, and efficient in operator-customer rapport building.

It is still another object of the invention, to provide a comment generation system which reduces the time for training the telemarketers.

It is still another object of the invention, to have a process of displaying the natural language comment.

It is still another object of the invention, to provide a comment generation system which can be located on a mobile network.

It is still another object of the invention, to provide a comment generation system which can be implemented on a Smartphone or internet or the like.

### BRIEF DESCRIPTION OF THE DRAWINGS

The invention will now be described with reference to the accompanying figures in which:

FIG. 1 depicts a comment generation system for generating a list of natural language comments during a telecommunication session according to an embodiment of the invention;

FIG. 2 is a block diagram illustrating the method for generating a list of natural language comments during a telecommunication session between a customer and an operator in accordance with the present invention;

FIG. 3 illustrates the dynamic interface as generated by the comment generation system;

FIG. 4 shows the network architecture of the comment generation system located on a server and connected to a plurality of computing devices to be used by the operators;

FIG. 5 illustrates the templates used in the comment generation system; and

FIG. 6 illustrates another template related to holidays, observances and news which are used in the comment generation system.

### DETAILED DESCRIPTION OF THE INVENTION

Although described in the context of a call center or a communication center, it is to be understood that this system and method is contemplated and within the scope of embodiments of the present invention to be applied to any system and method where agents, and more particularly service agents, whether human or automated, are called upon to assist multiple customers at any given time, either simultaneously or substantially simultaneously.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

The present invention describes a comment generation system for generating a list of natural language comments during a telecommunication session between a customer and an operator, wherein the system comprises of means for receiving a geographical information of the customer, means for obtaining a first dataset from a repository and a second dataset from at least one dynamic source, wherein the first dataset and the second dataset are associated with the geographical information and means for processing the geographical information, the first dataset and the second dataset to generate a dynamic interface comprising of a contextual content and the list of natural language comments.

The comment generation system also comprises of means for retrieving and displaying the dynamic interface to be used subsequently by the operator in the communication session.

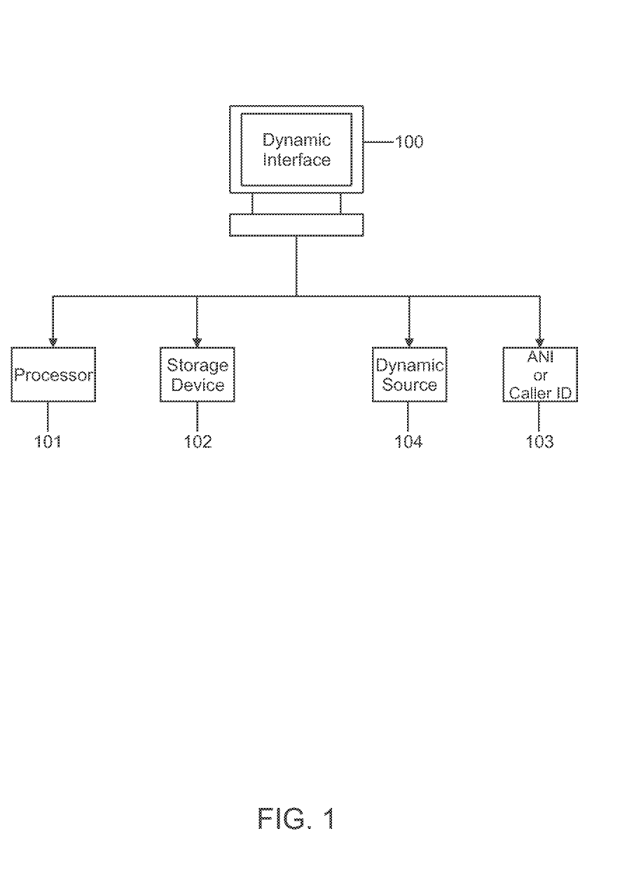

FIG. 1 shows the comment generation system which comprises of a computer system 100 to aid an operator in telecommunication session with a customer. The computer system includes a processor 101 and a storage device 102.

In an embodiment of the invention, the storage device 102 can be a disk drive located on the operator's computer terminal or it can be a remote database located on a plurality of servers connected to a plurality of computing devices to be used by the operators.

The computer system 100 is configured to an Automatic Number Identification (ANI) or the caller-ID 103 to obtain the phone number of the customer. This Automatic Number Identification (ANI) or the caller-ID 103 is provided either by a local structure or the telephone company. This automatic Number Identification (ANI) or the caller-ID 103 provides the full phone number including the area code of the customer, which is used by the comment generation system to receive the geographic information of the customer.

In another embodiment of the invention, the comment generation system can use the caller's postal code, instead of their phone number. For existing customers, the postal code is stored in their customer database in the storage device 102 and can be retrieved automatically or the operator can verbally request it from the customer and input it manually into the comment generation system.

In yet another embodiment of the invention, the comment generation system uses the existing customer database of the storage device 102 to retrieve the geographical information of the customer.

In yet another embodiment of the invention, the operator can verbally request the geographic location name from the customer and input it manually into the comment generation system.

Once the geographic information is received, the processor 101 obtains the first dataset from the storage device 102 acting as the repository. The storage device 102 stores local information consisting of data related to at least one of news, area attractions, educational institutes, regional sports teams, demographic history, upcoming events, festivals, holidays and observances. The processor 102 obtains the second dataset from at least one dynamic source 104 and consists of data related to date, time, current weather and weather forecast.

In yet another embodiment of the invention, the dynamic source 104 for the second dataset can be internet or a third party service provider.

In yet another embodiment of the invention, the second dataset contains data that is contextually programmed as per the first dataset. This means that the comment generation system uses information stored in both the datasets to generate the natural language comments. For example, the information regarding the usual weather in New York for a spring season i.e. between 18 degree Celsius to 25 degree Celsius is stored in the first dataset and the current temperature of New York retrieved from the second dataset is 28 degree Celsius. The comment generation system based on this information and conditional logic will generate a comment for the operator like “hey! It's getting warm in New York,” when in telecommunication session with a customer.

The geographic information, the first dataset and the second dataset are then processed by the processor 101 of the comment generation system to generate a dynamic interface comprising of contextual content and the list of natural language comments wherein the list of natural language comments is generated on the basis of the contextual content. The dynamic interface is retrieved and displayed on the computer system 100 for the operator's assistance while in telecommunication session with the customer. The natural language comments are meaningful sentences in a predefined language and since they are based on the dynamic interface these comments are generated on real time basis.

In yet another embodiment of the invention, the natural language can be English or Hindi or any other language.

In yet another embodiment of the invention, the comment generation system generates comments in natural language or translated language.

In yet another embodiment of the invention, the comment generation system is a computing device of the operator.

In yet another embodiment of the invention, the comment generation system comprises at least one server and a plurality of computing devices to be used by the operators wherein the server generates the dynamic interface and transmits the dynamic interface to the plurality of computing devices. The dynamic interface is then displayed on the computing devices.

In still another embodiment of the invention, the natural language comments are ranked and categorized according to programmable logic of the comment generator. The processor 101 is setup with conditional logic to generate appropriate comments. It takes all the information and dynamically generates natural language comments, based on the logic programmed. For example if an operator is in telecommunication session with a customer from a geographic location which has experienced earthquakes in the recent hours then according to the programmable logic this information will be ranked higher by the comment generation system and the comment related to the earthquake like “I heard there were tremors experienced in your locality” will be displayed or if it is snowing in a particular geographic location then the weather categorization will be paid higher value by the processor 101 based on the programmable logic and comment related to snow like “I think it's going to snow tomorrow as well” will be displayed on the dynamic interface.

In still another embodiment of the invention, the natural language comments are built as per the company policies and political and cultural customs.

In an embodiment of the invention, the processor 101 is setup with conditional logic to generate the natural language comments which are structured around the ‘commonality’ and ‘empathy’ themes to build rapport with the customer.

In yet another embodiment of the invention, the comment generation system can be implemented on a Smartphone or internet or the like.

In yet another embodiment of the invention, the comment generation system can be located on a mobile network.

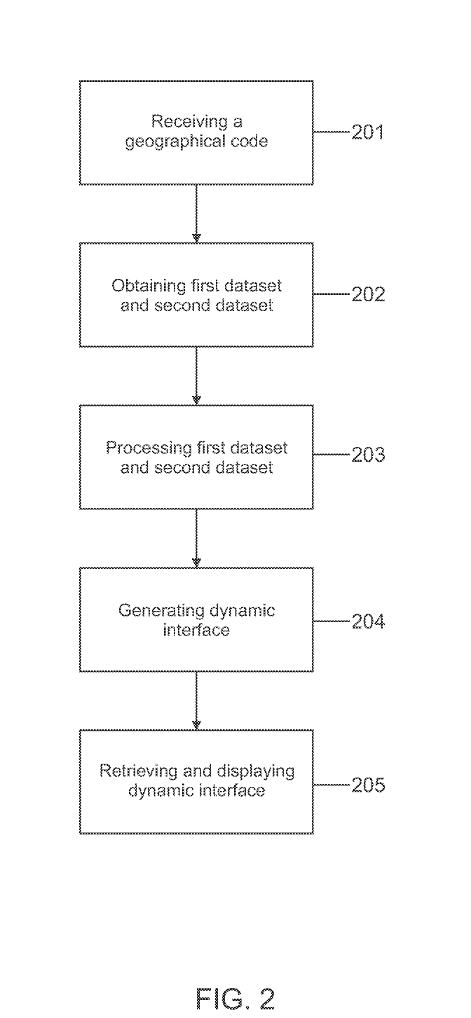

FIG. 2 describes the method for generating a list of natural language comments during a telecommunication session between a customer and an operator. Step 201 involves receiving a geographical code corresponding to the customer's location.

In yet another embodiment of the invention, the geographical code is selected from a group consisting of telecommunication phone number, postal code.

In yet another embodiment of the invention, the geographical code can be retrieved automatically from an existing customer database or telecommunication area code database.

In yet another embodiment of the invention, the geographical code is requested from the customer by the operator during the telecommunication session.

Step 202 involves obtaining a first dataset from a repository wherein the first dataset comprises of data related to at least one of news, area attractions, educational institutes, regional sports teams, demographic history, upcoming events, festivals, holidays and observances and obtaining a second dataset from at least one dynamic source wherein the second dataset comprises of data related to date, time, current weather and weather forecast. The first dataset and the second dataset being associated with the geographical code.

Step 203 comprises of processing the first dataset and the second dataset by a comment generator.

In an embodiment of the invention, the first dataset and the second dataset are processed by the comment generator in a computing device of the operator.

In yet another embodiment of the invention, the first dataset and the second dataset are processed by the comment generator in a server to generate the dynamic interface and transmit the dynamic interface to a plurality of computing devices corresponding to a plurality of operators.

Step 204 involves generating a dynamic interface, wherein the dynamic interface comprises of a contextual content and the list of natural language comments wherein the list of natural language comments is a meaningful sentence in a predefined language generated on the basis of the contextual content and Step 205 involves retrieving and displaying the dynamic interface on the operator's computer terminal to be used in the communication session.

In yet another embodiment of the invention, the comment generator can be customized for a pre-defined set of customers. This customization of the comment generator is based upon factors like ethnicity, geography, age, sex etc. This customization is fed into the programmable logic of the comment generator system and helps in building a good rapport between the operator and the customer.

In yet another embodiment of the invention, the method for generating a list of natural language comments involves determining if the customer is a repeat customer, for example, to determine if the system should retrieve prior sales information. If the customer is a repeat customer, the comment generator system retrieves any known customer attributes, e.g. prior sales and other information regarding the customer and displays it on the dynamic interface of the comment generator system.

In yet another embodiment of the invention, the comment generator takes dynamic inputs from the social media account of the customer. The comments related to the media account of the customer are displayed in the list of natural language comments for the operator and could be useful for them in breaking the ice with the customer.

In yet another embodiment of the invention, the comment generation system is used by an operator to interact with a customer wherein the operator represents an outsourced service provider organization. A suitable example in this context is the services provided by a US based firm outsourcing its work to an Indian operator. In this context the US based firm facilitates the Indian operator with a comment generation tool.

The comment generation system of the present invention comprises of data fields which are used by the system to generate the dynamic interface.

In an embodiment of the invention the following data fields can be used in the script generator.

<current_temp>, <current_time>, <weather_condition_today>, <weather_condition_tomorrow>,
<high_temp_today>, <high_temp_tomorrow>, <low_temp_today>, <low_temp_tomorrow>,
<current_month>, <current_date>, <area_code>, <location_name>, <attraction_1>,
<attraction_2>, <attraction_3>, <univ_name_1>, <univ_name_2>, <Football>, <Baseball>, <Ice
Hockey>, <Basketball>, <Football_Team>, <Baseball_Team>, <Ice Hockey_Team>,
<Basketball_Team>.

The comment generation system is based on conditional logic in order to display the list of natural language comments.

The following are the examples of the conditional logic used:

1. if<current_temp> less than 2 degree Celsius, then display: “I believe its freezing in <current_location_name> today.”

In the above example the computer generation system is fed with the logic that if the current temperature of the customer's location is less than 2 degree Celsius then the dynamic interface will display the comment “I believe its freezing in <current_location_name> today.”

2. if<weather_condition_tomorrow> equals <snow>, <rain>, then display script, “Looks like it's going to <weather_condition_tomorrow> tomorrow”.

In this second example the computer generation system is fed with the logic that if the weather forecast of the customer's location predicts that it will rain or snow then the dynamic interface will display the comment “Looks like it's going to <weather_condition_tomorrow> tomorrow”.

The data fields of the comment generation system are categorized into two sets. The first set comprises of the data fields that can be used for setting the conditional logic. These data fields are the following:

<current_temp>
<current_time>
<weather_condition_today>
<weather_condition_tomorrow>
<high_temp_today>
<low_temp_today>
<high_temp_tomorrow>
<low_temp_tomorrow>
<current_month>
<current_date>

In yet another embodiment of the invention, the data fields that can be used for setting the conditional logic are provided with permitted values and customizations that can be stored in the comment generation system. For example the <current_time> data field is provided with 24 values which will show list in increments of 30 mins, example 1:00 am, 1:30 am, 2:00 am etc. on the dynamic interface.

The second set comprises of the data fields which will not be used in the conditional logic, but can be used directly in the comment generation system. These data fields comprise of the following:

<area_code> = Area Code
<location_name> = Location
<attraction_1>, <attraction_2>, <attraction_3> = Attraction names
<univ_name_1>, <univ_name_2> = University names
<Football>, <Baseball>, <Ice Hockey>, <Basketball> = Sports Type
<Football_Team>, <Baseball_Team>, <Ice Hockey_Team>,
<Basketball_Team> = Sports type and corresponding team name.

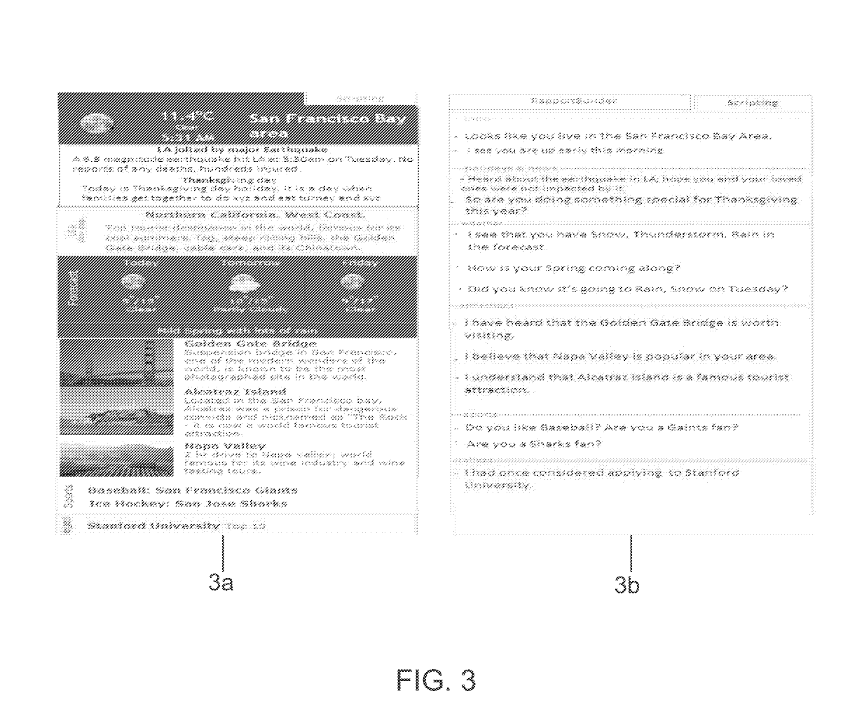

FIG. 3 shows the dynamic interface as displayed on the operator's computer terminal. The section 3a shows the contextual content and section 3b shows the list of natural language comments which are generated in real time on the basis of the contextual content.

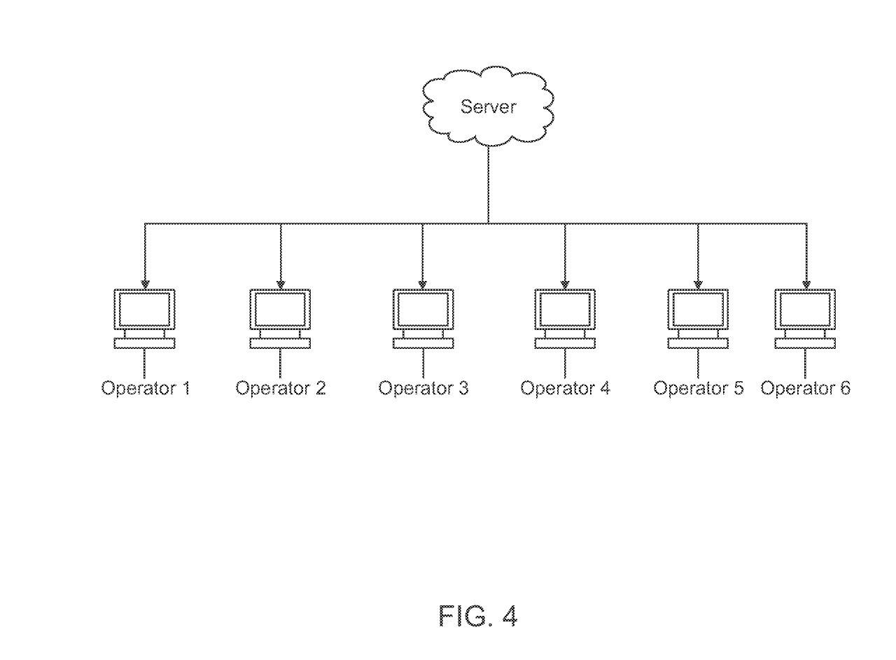

FIG. 4 shows another embodiment of the present invention illustrating the network architecture of the comment generation system located on a server and connected to a plurality of computing devices to be used by a plurality of operators. As shown in the FIG. 4 the comment generation system serves six operators. In this scenario the processing and obtaining of first dataset and second dataset are done on the server and the dynamic interface is provided by the comment generation system to the individual operator's.

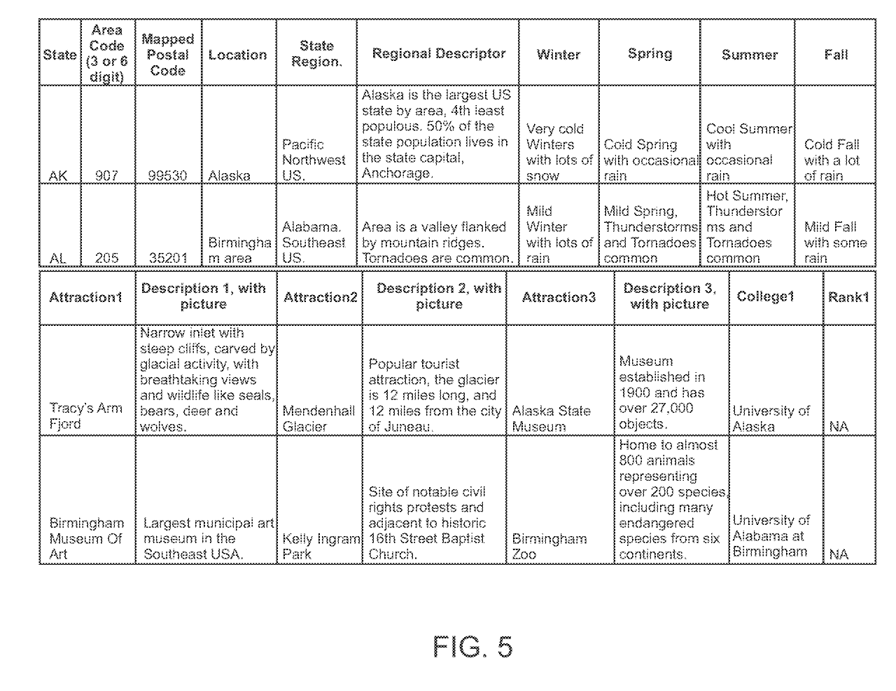

FIG. 5 illustrates the templates used in the comment generation system. The template shows the data that is processed by the comment generator for two different area codes or postal codes. The template includes data associated to location, state, regional descriptor, winter, spring, summer, fall, attraction1, description 1 with picture, attraction2, description 2 with picture, attraction3, description 3 with picture, college1,rank1 of the area codes or postal codes.

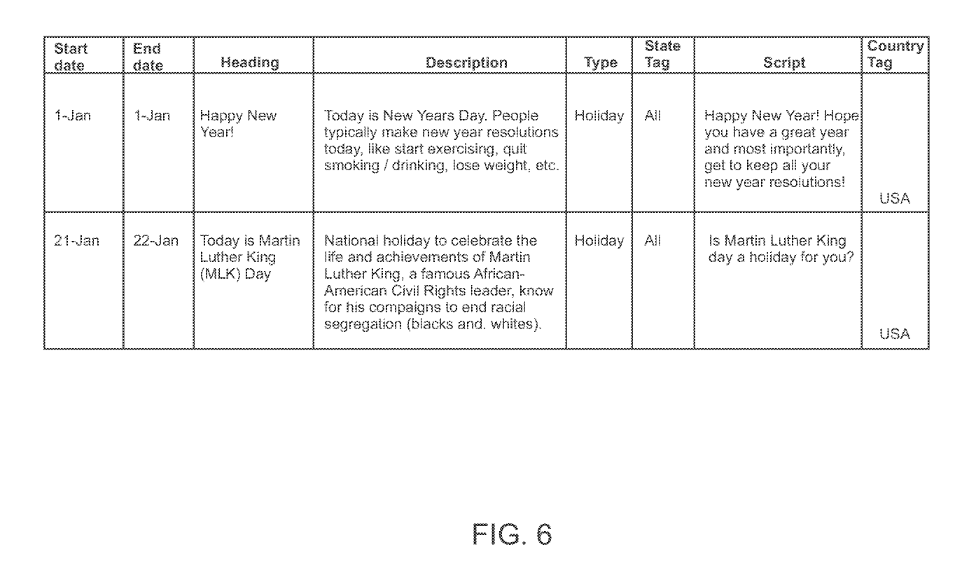

FIG. 6 illustrates another template related to holidays, observances and news which are used in the comment generation system. The template includes data associated to start date, end date, heading, description, type, state tag, script, and country tag.

The following are the natural language comments as generated by the comment generator:
Looks like you are calling from San Francisco Bay area.
I believe the 415 area code is from the San Francisco Bay area, right?
Looks like you live in the San Francisco Bay Area.
It's 10:34 pm; I see that you are up Late tonight. (if current time between 10 pm to 4 am)
You must be a morning person; you are up Early today. (if current time between 4:01 am to 8 am)
I believe it's very cold there today. (if current temp is less than 2 degree C.)
I believe it's very hot there today. (if current temp is greater than 30 degree C.)
How is your spring coming along? (display if Month=March, April, May)
Get ready for some shoveling; looks like it's going to Snow Tomorrow (display if weather forecast for tomorrow=snow)
I have heard that Golden Gate Bridge is worth visiting
I believe that Napa Valley is popular in your area.
Do you like Ice Hockey? Are you a fan of the Calgary Flames?
I had once considered applying to Stanford University.
I believe The University of Missouri is a great university.

There are many advantages of the comment generator as mentioned in the present invention. The comment generator system provides dynamic comments that enable call center agents to build rapport over the phone, by using contextually relevant conversational comments to break the ice. The comment generator is intuitive and flexible and can be customized by each service provider. The comment generator is powerful and agile, easy to use, and efficient in operator-customer rapport building.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for generating a list of natural language comments during a telecommunication session with a customer, the method comprising:
Receiving a geographical code corresponding to the customer's location;
obtaining a first dataset from a repository and a second dataset from at least one dynamic source, the first dataset and the second dataset being associated with the geographical code;
processing the first dataset and the second dataset by a comment generator to generate a dynamic interface, wherein the dynamic interface comprises of a contextual content and the list of natural language comments; and
retrieving the dynamic interface to be used in the communication session.

2. The method according to claim 1, wherein the geographical code is selected from a group consisting of telecommunication phone number, postal code.

3. The method according to claim 1, wherein the geographical code is retrieved automatically from existing customer database or telecommunication area code database.

4. The method according to claim 1, wherein the geographical code is requested from the customer during the telecommunication session.

5. The method according to claim 1, the first dataset and the second dataset are processed by the comment generator in a computing device.

6. The method according to claim 1, the first dataset and the second dataset are processed by the comment generator in a server to generate the dynamic interface and transmit the dynamic interface to a plurality of computing devices.

7. The method according to claim 1, wherein the comment generator takes dynamic inputs from the social media account of the customer.

8. The method according to claim 1, wherein the first dataset comprises of data related to at least one of news, area attractions, educational institutes, regional sports teams, demographic history, upcoming events, festivals, holidays and observances.

9. The method according to claim 1, wherein the second dataset comprises of data related to date, time, current weather and weather forecast.

10. The method according to claim 1, wherein the list of natural language comments is generated on the basis of the contextual content.

11. The method according to claim 1, wherein the list of natural language comments is generated on real time basis.

12. The method according to claim 1, wherein the telecommunication session comprises of an operator which can be selected from a group consisting of a sales personnel, a marketing personnel, a technical assistant or representing an outsourced service providers organization interacting with the customer using a telecommunication network.

13. A comment generation system for generating a list of natural language comments during a telecommunication session with a customer, the system comprising:
means for receiving a geographical information of the customer.
means for obtaining a first dataset from a repository and a second data set from at least one dynamic source, wherein the first dataset and the second dataset are associated with the geographical information;
means for processing the geographical information, the first dataset and the second dataset to generate a dynamic interface comprising of a contextual content and the list of natural language comments; and
means for retrieving and displaying the dynamic interface

14. The comment generation system according to claim 13, wherein the geographical information is selected from a group consisting of geographical location name, telecommunication phone number, postal code.

15. The comment generation system according to claim 13, wherein the geographical information is retrieved automatically from existing customer database or telecommunication area code database.

16. The comment generation system according to claim 13, wherein the geographical information is requested from the customer.

17. The comment generation system according to claim 13, wherein the comment generation system is installed on a computing device.

18. The comment generation system according to claim 13, wherein the comment generation system is located on a server.

19. The comment generation system according to claim 18, wherein the server generates the dynamic interface and transmits the dynamic interface to a plurality of computing devices.

20. The comment generation system according to claim 13, wherein the first dataset comprises of data related to at least one of news, area attractions, educational institutes, regional sports teams, demographic history, upcoming events, festivals, holidays and observances.

21. The comment generation system according to claim 13, wherein the second dataset comprises of data related to date, time, current weather, weather conditions and any abnormal occurrence in weather.

22. The comment generation system according to claim 13, wherein the list of natural language comments is generated on the basis of the contextual content.

23. The comment generation system according to claim 13, wherein the list of natural language comments is generated on real time basis.

24. The comment generation system according to claim 13, wherein the operator can be selected from a group comprising of a sales personnel, a marketing personnel, a technical assistant or representing an outsourced service providers organization interacting with the customer using a telecommunication network.
